(19) United States
(12) Patent Application Publication
(10) Pub. No.: US 2010/0020033 A1
(43) Pub. Date: Jan. 28, 2010

(54) SYSTEM, METHOD AND COMPUTER PROGRAM PRODUCT FOR A VIRTUAL KEYBOARD

(76) Inventor: Obinna Ihenacho Alozie Nwosu, London (GB)

Correspondence Address: Leason Ellis LLP, 81 Main Street, Suite 503, White Plains, NY, 10601, US

(21) Appl. No.: 12/497,649

(22) Filed: Jul. 4, 2009

Related U.S. Application Data
(60) Provisional application No. 61/083,176, filed on Jul. 23, 2008.

(51) Int. Cl. G06F 3/041

(52) U.S. Cl. 345/173

(57) ABSTRACT

A method and a system for a virtual keyboard utilizing a computer input device includes defining at least first, second and third bounded areas associated with the input device. A set of nine characters is assigned to each of the bounded areas. Contacts and movements associated with the input device within the bounded areas are detected. A one of eight of the nine characters assigned to a bounded area is selected upon detection of a continuous contact during a movement from a beginning position to an end position associated with the bounded area. The selecting is determined by a linear direction from the beginning position to the end position. A ninth character of the nine characters assigned to the bounded area is selected upon detection of a momentary contact associated with the bounded area.

### CROSS-REFERENCE TO RELATED APPLICATIONS

The present Utility patent application claims priority benefit of the U.S. provisional application for patent Ser. No. 61/083,176 filed on 23 Jul. 2008 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to text input. More particularly, the invention relates to a method and means for text input on touch screen devices that comprises three relatively large buttons.

### BACKGROUND OF THE INVENTION

As more people move to using their mobile phone or PDA as their primary means of internet access, email and instant messaging, the need for an effective mechanism for input of text increases. Many inventors, individuals and organizations have tried to fill this need with inventions such as physical thumb boards (integrated and external), handwriting recognition and the use of a stylus, speech to text input, chorded text entry, and novel keyboard layouts. These approaches have been the subject of a number of studies.

The research into Human-Computer Interaction (HCI) in recent years is extensive, and a paper that well describes critical aspects of design of data entry mechanisms for small devices is “Text Input on Mobile Devices: Designing a Touch Screen Input Method” by Roope Rainisto, from the Helsinki University of Technology, published May 22, 2007. The thesis explains the applicability of Fitts's law to touch screen devices, and the advantages of virtual keys over hardware keyboards, some general thoughts on input method design, and the problem of how to provide the best text input experience on small touch screen devices with both physical and performance limitations.

Some of the conclusions of this thesis are as follows. Keyboard entry is still the most practical form of input for a mobile device. Touch screen only devices provide the most flexibility for a device interaction. Physical keyboards provide haptic feedback, which is essential for touch typing, or typing without looking at the keys. Fitts's law shows that the larger the keys and the less distance that a user's fingers need to move, the faster the potential typing speed. It is ideal to keep the cost to correct a data entry error very low (i.e., to avoid prediction). Keeping to familiar layouts like QWERTY is a massive advantage in acceptance of a new keyboard system. Mobile phones, PDAs and other small devices have limited screen space. The ability to allow for one-handed input is a significant desired ability.

The problem with current text input methods is that existing software or virtual keyboards make it difficult if not impossible to touch type and have error rates (i.e., incorrect button presses) that are significantly more frequent on touch screens than on physical keyboards therefore slowing down data entry rates. Current methods with predictive solutions require the user to concentrate deeply and may have a high cost to correct while providing zero tolerance for misspelled words. Furthermore, many solutions have large learning curves for the average QWERTY layout aware user, are often optimized for two handed typing as opposed to one handed typing, can take up a lot of valuable screen space that may be better used for information output as opposed to data entry, often have keys that are too small for comfortable, fast, accurate and efficient data entry, have layouts that are too complicated for fast and accurate data entry, and require significant movement of the finger and hand therefore capping the maximum possible speed of data entry.

A solution is needed that addresses all of these problems, providing a virtual keyboard alternative that is optimized for thumb or finger input, can be used with a single hand, can allow touch typing if the user is familiar with the QWERTY or other such common layout, has large conveniently placed buttons, keeps the risk of missing a key to a minimum, requires the minimum of movement of the hand and fingers, does not rely on predictive mechanisms yet can work in conjunction with these mechanisms if required, allows for very fast location of keys, and takes up relatively little screen space compared to its competitors.

Currently known touch screen text input methods have tried with their software to address shortcomings of touch screen devices over hard keys or mechanical keyboards in various ways. However, no currently known text input methods for touch screen devices have succeeded in providing touch typing capability together with low error rates in a low cost application. Furthermore, touch typing is nearly impossible on any predictive system. One currently known solution has fifteen keys and therefore low data entry rates or words per minute (w.p.m.) and high error rates, and so requires text prediction. Another currently known solution has nine only alphabet keys plus three other punctuation/control keys, twelve keys in total. This solution specifically requires the learning of a completely new keyboard layout based on the frequency of words in the English language. Yet another known solution for some of the difficulties encountered at present uses six wide and short keys arranged in two or three rows and some control keys. This solution relies on thumb blows, and uses text prediction to help determine which word a user is trying to type. For dictionary words this system is fast; however, as the first solution mentioned above there is a high cost for correction. Other known devices such as some PDAs and Smartphones have virtual keyboards. These are full keyboards that also perform some corrective prediction.

Another known approach is to have ten keys with letters spread across all of the keys, similarly to a digital phone dial. To generate a letter a user must continue to press the same key and cycle through the letters on the key until they get to the letter they need. This approach does not require prediction; however, as there are on average three letters per key, a user often needs to click each key multiple times to generate a letter, increasing the number of key interactions per letter over approaches with one letter per key. Also, ten keys mean a lower theoretical overall typing speed.

Another known approach to improving the speed of interaction with touch screen only devices is a system which supports an interpretation of a slide or swipe motion across the virtual keyboard without reference to a start or finish point, and with one finger. The slide motion is used in order to generate certain functions such as a space or delete, the function is determined by the direction of the slide. In the case of these two functions the movement is intuitive and obvious; whereas without a start or finish reference, to generate all of the letters of a western alphabet for example would require the learning of numerous non-intuitive directions, This approach provides a means of handling a small number of simple symbols or actions as opposed to being a full data entry system.

In view of the foregoing, there is a need for improved techniques for providing a virtual keyboard that enables fast and accurate typing, has large easy to use keys, enables touch typing, and takes up relatively little screen space. To increase utility and ease of use, it would further be desirable if a virtual keyboard required the user to learn only a few simple intuitive gestures.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B, 1C, and 1D illustrate an exemplary virtual keyboard, in accordance with an embodiment of the present invention. FIG. 1A shows the virtual keyboard in a lower case mode. FIG. 1B shows the virtual keyboard in a shift or caps lock mode. FIG. 1C shows the virtual keyboard in an Alt mode, and FIG. 1D shows the virtual keyboard in a function mode;

FIGS. 1E through 1K illustrate exemplary actions that may be performed by a user of an exemplary virtual keyboard, in accordance with an embodiment of the present invention. FIGS. 1E, 1F and 1G illustrate actions for entering text, specifically a tap, a slide and a combination of separate taps and slides, respectively. FIGS. 1H, 1I, 1J, and 1K illustrate actions that a user may execute to perform specific functions, specifically a delete action, a space action, a return action, and a stop/start or open/close action, respectively; and

FIG. 2 illustrates an exemplary virtual keyboard with keyboard guide areas at the top of the screen, in accordance with an embodiment of the present invention.

FIG. 3 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a method, system and computer program product for a virtual keyboard is presented.

In one embodiment, a method for a virtual keyboard utilizing a computer input device is presented. The method includes steps of defining at least first, second and third bounded areas associated with the input device. The method includes assigning a set of nine characters to each of the bounded areas. The method includes detecting contacts and movements associated with the input device within the bounded areas. The method includes selecting a one of eight of the nine characters assigned to a bounded area upon detection of a continuous contact during a movement from a beginning position to an end position associated with the bounded area, wherein the selecting being determined by a linear direction from the beginning position to the end position. The method further includes selecting a ninth of the nine characters assigned to the bounded area upon detection of a momentary contact associated with the bounded area. Another embodiment further includes a step of assigning a different set of nine characters to each of the bounded areas upon detection of a continuous contact during a generally circular movement associated with a bounded area. Yet another embodiment further includes a step of assigning a different set of nine characters to each of the bounded areas upon detection of a continuous contact for a predetermined time without movement. In another embodiment the computer input device includes a touch input of a display screen and the bounded areas are defined adjacently. Another embodiment further includes a step of selecting a space character upon detection of a continuous contact during a movement from the first bounded area through the second bounded area to the third bounded area. Yet another embodiment further includes a step of selecting a backspace character upon detection of a continuous contact during a movement from the third bounded area through the second bounded area to the first bounded area. Still another embodiment further includes a step of selecting a return character upon detection of continuous contact during a movement passing through the bounded areas twice. Yet another embodiment further includes a step deactivating the detection upon detection of continuous contact during a movement passing through the bounded areas three times.

In another embodiment a method for a virtual keyboard utilizing a computer input device is presented. The method includes steps for defining bounded areas associated with the input device, steps for assigning characters to each of the bounded areas, steps for detecting contacts and movements within the bounded areas, steps for selecting a characters upon detection of a continuous contact during a movement and steps for selecting a characters upon detection of a momentary contact. Another embodiment further includes steps for assigning different characters to each of the bounded areas. Yet another embodiment further includes steps for selecting a space character. Still another embodiment further includes steps for selecting a backspace character. Another embodiment further includes steps for of selecting a return character. Yet another embodiment further includes steps for deactivating the detection.

In another embodiment a computer program product for a virtual keyboard utilizing a computer input device is presented. The computer program product includes computer code for defining at least first, second and third bounded areas associated with the input device. Computer code for assigns a set of nine characters to each of the bounded areas. Computer code detects contacts and movements associated with the input device within the bounded areas. Computer code for selects a one of eight of the nine characters assigned to a bounded area upon detection of a continuous contact during a movement from a beginning position to an end position associated with the bounded area, wherein the selecting being determined by a linear direction from the beginning position to the end position. Computer code for selects a ninth of the nine characters assigned to the bounded area upon detection of a momentary contact associated with the bounded area. A computer-readable medium for stores the computer code. Another embodiment further includes computer code for assigning a different set of nine characters to each of the bounded areas upon detection of a continuous contact during a generally circular movement associated with a bounded area. Yet another embodiment further includes computer code for assigning a different set of nine characters to each of the bounded areas upon detection of a continuous contact for a predetermined time without movement. In another embodiment the computer input device includes a touch input of a display screen and the bounded areas are defined adjacently. Another embodiment further includes computer code for selecting a space character upon detection of a continuous contact during a movement from the first bounded area through the second bounded area to the third bounded area. Yet another embodiment further includes computer code for selecting a backspace character upon detection of a continuous contact during a movement from the third bounded area through the second bounded area to the first bounded area. Still another embodiment further includes computer code for selecting a return character upon detection of continuous contact during a movement passing through the bounded areas twice. Yet another embodiment further includes computer code for deactivating the detection upon detection of continuous contact during a movement passing through the bounded areas three times.

In another embodiment a system for a virtual keyboard utilizing a computer input device is presented. The system includes means for defining bounded areas associated with the input device, means for assigning characters to each of the bounded areas, means for detecting contacts and movements within the bounded areas, means for selecting a characters upon detection of a continuous contact during a movement and means for selecting a characters upon detection of a momentary contact. Another embodiment further includes means for assigning different characters to each of the bounded areas. Yet another embodiment further includes means for selecting a space character. Still another embodiment further includes means for selecting a backspace character. Yet another embodiment further includes means for of selecting a return character. Still another embodiment further includes means for deactivating the detection.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Preferred embodiments of the present invention provide a computer program written for a target platform. The architecture may be any computer that has a touch screen that registers single or multi-touch inputs. At a minimum this is point of contact, movement while in contact with the screen and finally the point of separation. A non-limiting example is a touch screen mobile phone such as, but not limited to, the IPhone, HTC Touch or Nokia N810. Any programming language that is supported by the target platform and capable of accepting inputs from the touch screen and rendering outputs from the screen may be used. Preferred embodiments are virtual keyboard solutions that are activated by the operating system used in the target platform.

Preferred embodiments provide a mechanism for data entry that is a form of virtual keyboard designed for touch screen displays. Preferred embodiments use familiar keyboard layouts and have large, difficult to miss keys that require little or no movement between each letter typed, depending on usage. The use of a familiar QWERTY or any other standard layout in preferred embodiments provides a near zero learning curve, and this layout is optimized for typing with one hand. The mechanism in preferred embodiments allows for touch typing. Mechanical hard key devices remain popular because they allow for touch typing, which has eluded most other currently known touch screen keyboards, and is nearly impossible on any predictive system.

A preferred embodiment comprises only three large software buttons arranged horizontally next to each other for defining bounded areas associated with the input device, and therefore enables a faster typing rate than current devices with more keys as predicted by Fitts's law. Text prediction is not necessary for preferred embodiments, and therefore the cost per correction is generally the same as for a hard keyboard. The small number of large keys allow for much quicker and more accurate input. Preferred embodiments present a layout that is very similar to a normal full sized keyboard layout.

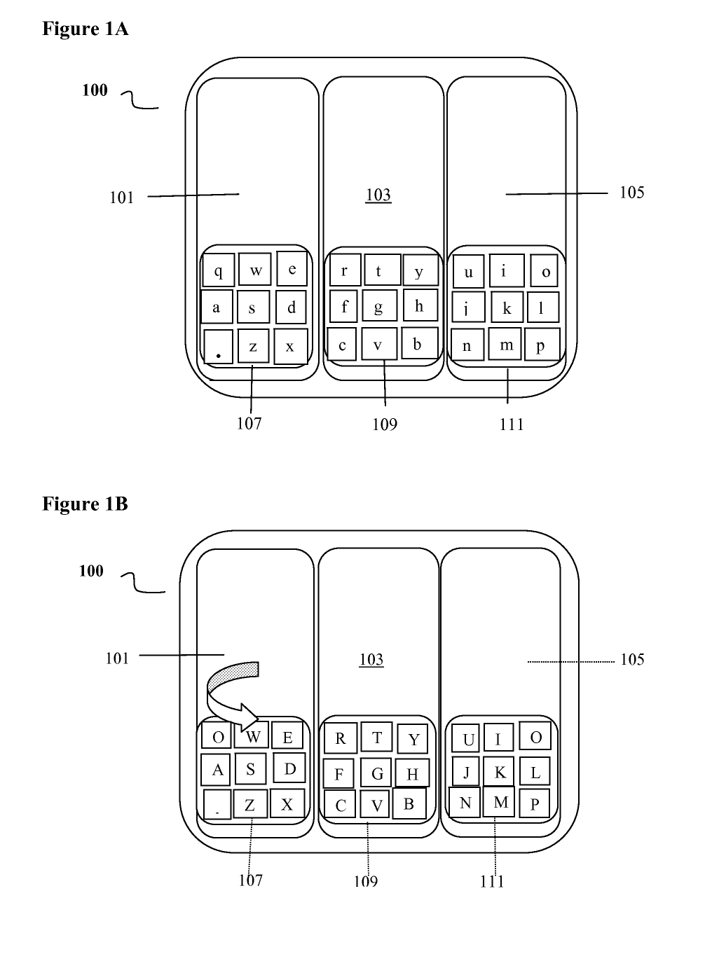

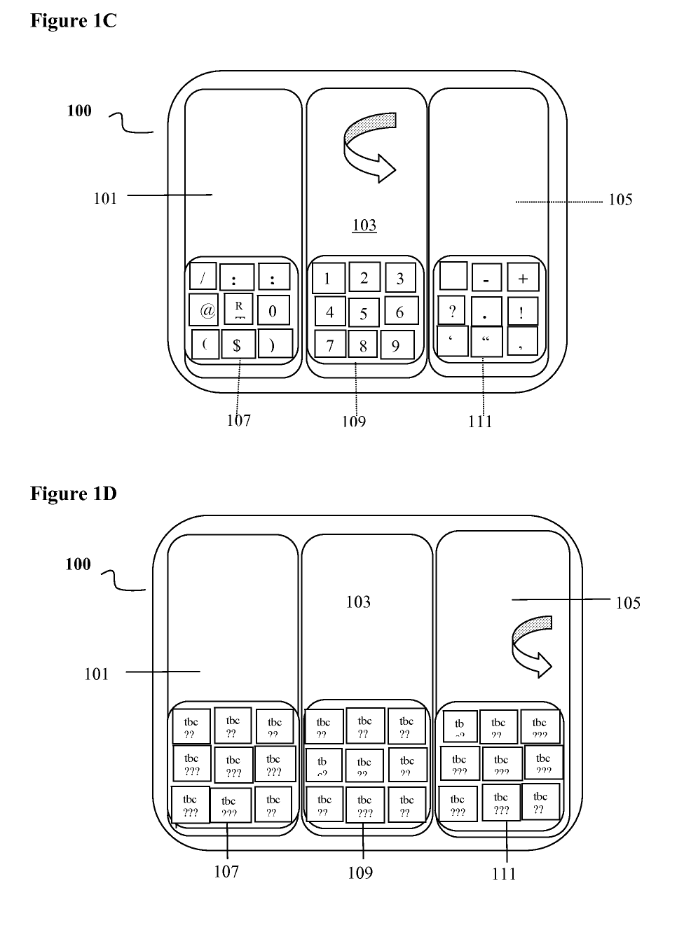

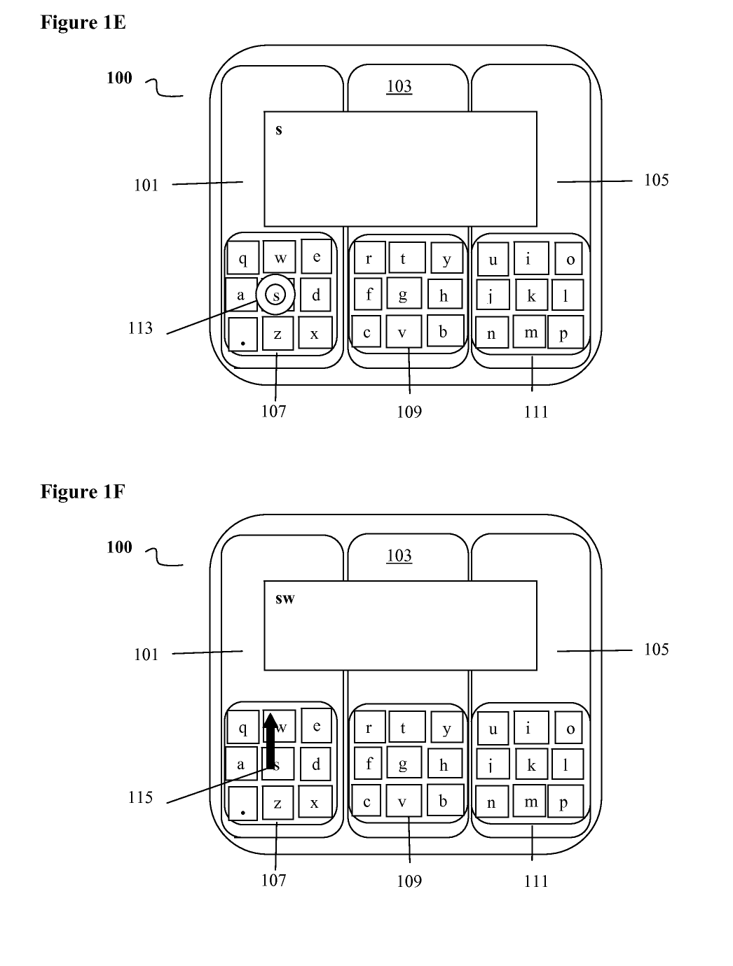

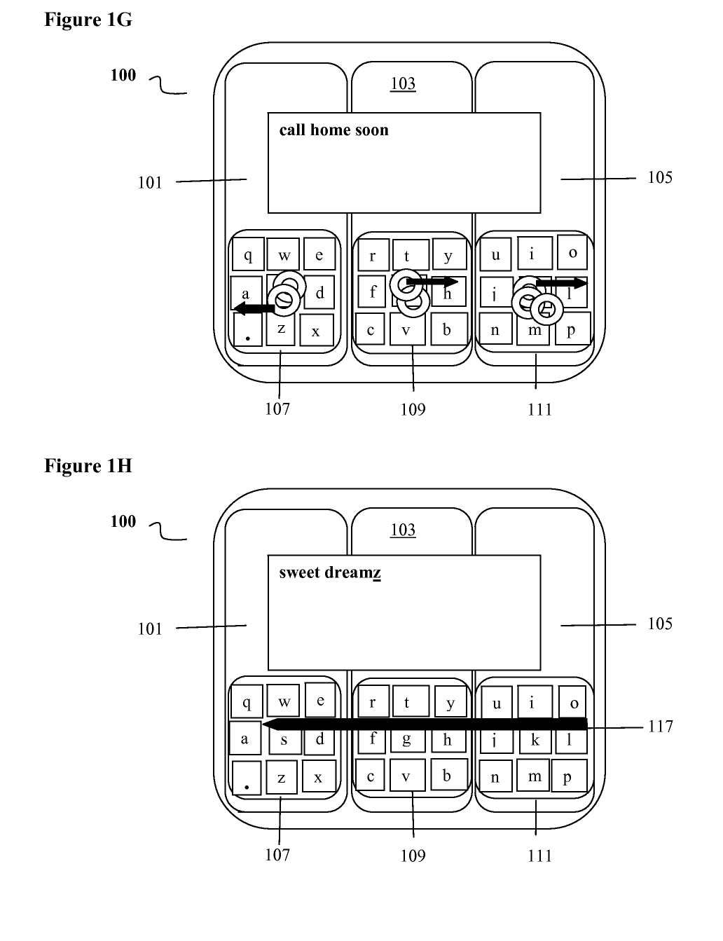

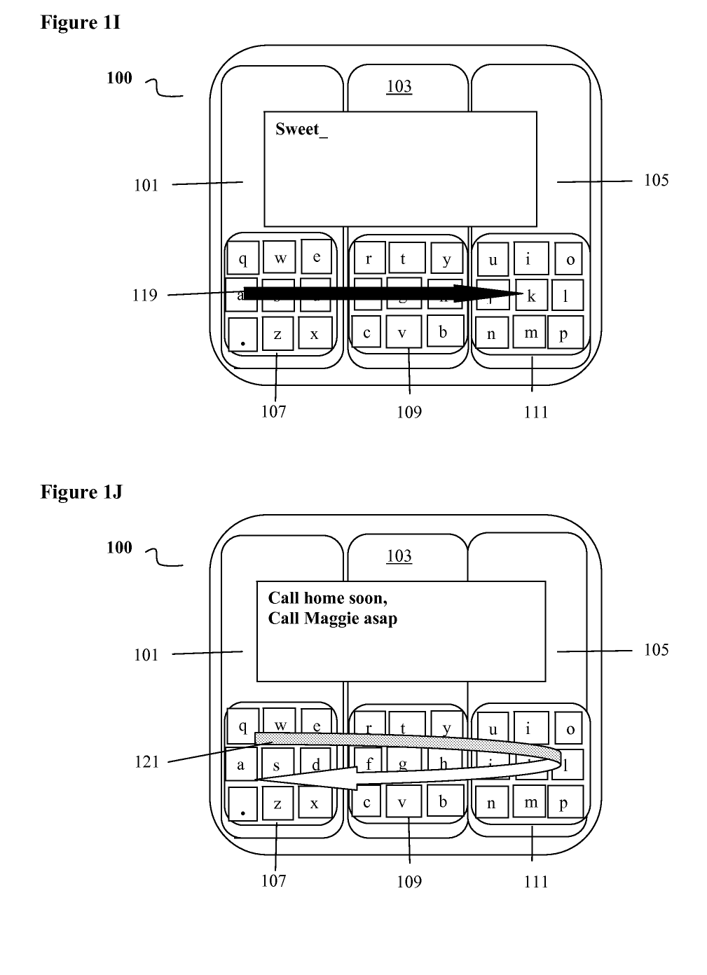

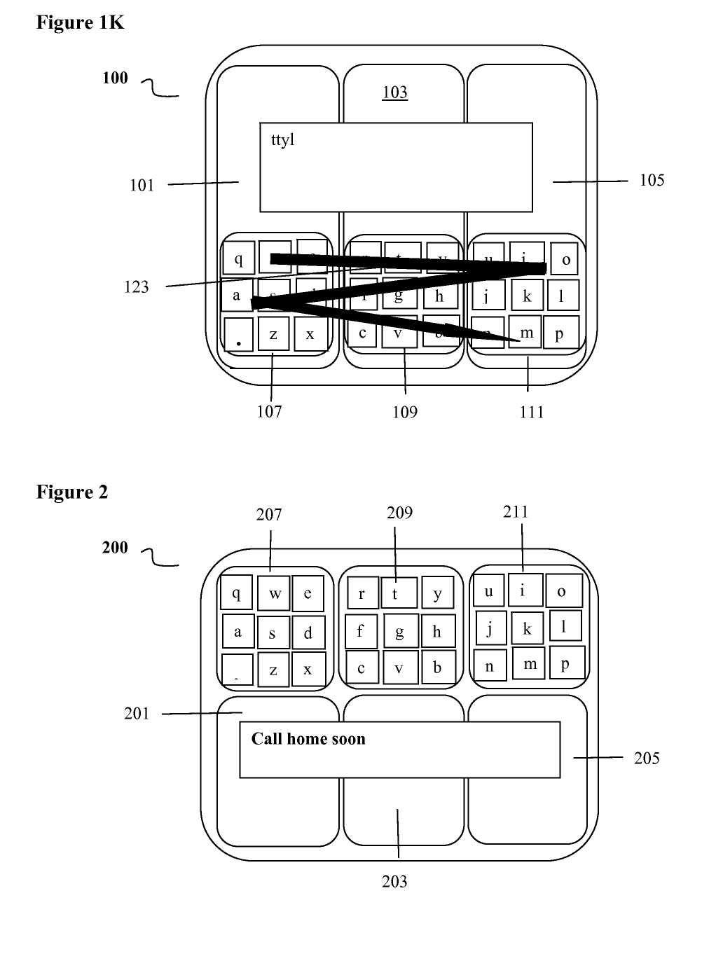

FIGS. 1A, 1B, 1C, 1D, 1E, 1F, 1G, 1H, 1I, 1J, and 1K illustrate an exemplary virtual keyboard 100, in accordance with an embodiment of the present invention. FIG. 1A shows virtual keyboard 100 in a lower case mode. FIG. 1B shows virtual keyboard 100 in a shift or caps lock mode. FIG. 1C shows virtual keyboard 100 in an Alt mode, and FIG. 1D shows virtual keyboard 100 in a function mode. In the present embodiment virtual keyboard 100 is implemented on a target platform with touch screen capabilities. Virtual keyboard 100 comprises three buttons 101, 103 and 105 with keyboard guide areas 107, 109 and 111 showing assigned characters of each of the bounded areas comprising buttons 101, 103 and 105. Keyboard guide areas 107, 109 and 111 each have nine characters or symbols that the corresponding button is currently set to activate. In the present embodiment in lower case mode and shift or caps lock mode, keyboard guide area 107 on button 101 comprises the letters q, w, e, a, s, d, z, and x and a period. Keyboard guide area 109 on button 103 comprises the letters r, t, y, f, g, h, c, v, and b. Keyboard guide area 111 on button 105 comprises the letters u, i, o, j, k, l, n, m, and p. This configuration closely resembles a standard QWERTY layout. Those skilled in the art, in light of the present teachings, will readily recognize that various other layouts may be used in alternate embodiments.

In the present embodiment, on virtual keyboard 100, when a user makes a circular motion anywhere on button 101, the shift or caps lock mode is activated. This is one steps or means for assigning different characters to each of the bounded areas. In the shift or caps lock mode the user is able to type capital letters. A circular motion made on button 103 activates the Alt mode. In the Alt mode the user is able to type various symbols and numbers. In the present embodiment in the Alt mode, keyboard guide area 107 comprises a forward slash, a colon, a semicolon, an at symbol, a return key, a zero, parentheses, and a dollar sign. Keyboard guide area 109 comprises the numbers one through nine, and keyboard guide area 111 comprises a space, a dash, a plus sign, a question mark, a period, an exclamation point, an apostrophe, quotes, and a comma. Alternate embodiments may display various different keys and key configurations in the Alt mode. In the present embodiment, a circular motion made on button 105 activates the function mode. In the function mode, the keys in keyboard guide areas 107, 109 and 111 may be programmed to perform various functions such as, but not limited to, save, send message, delete, move cursor up, move cursor down, move cursor left, move cursor right, generate one or more user defined phrases, load one or more user defined applications, etc. In alternate embodiments the various modes may be located on different buttons.

In typical use of the present embodiment, each button enables a user to perform eleven separate actions to generate key presses. Contacts and movements within the bounded areas are detected. One such action is a tap, which is a touch anywhere on the button and a release of the button with little or no lateral movement while in contact with the screen, as shown by way of example in FIG. 1E. A user may also perform eight different slides. A slide is a touch anywhere on the button then a lateral movement north, south, east, west, north east, north west, south east, or south west from the point of initial touch and a release of the button, as shown by way of example in FIG. 1F. The final two motions are circle motions. A circle motion is a touch anywhere on the button and a clockwise or counterclockwise slide motion ending close to the initial touch point, as shown by way of example in FIGS. 1B, 1C and 1D. Buttons 101, 103 and 105 also recognize a touch and hold action for a predefined amount of time that changes or resets the mode of virtual keyboard 100 such that subsequent actions generate a different character. The touch and hold action could also activate and de-activate the Shift, Alt and Function modes. This is another steps or means for assigning different characters to each of the bounded areas. Those skilled in the art, in light of the present teachings, will readily recognize that alternate embodiments may enable other types of motions on the buttons such as, but not limited to, a circle motion within the button area, a double tap, a square shaped motion, a triangular shaped motion, a star shaped motion where the star has any number of points, a figure of eight motion, an ichthys or fish shaped motion, etc.

In the present embodiment, the tap action and the eight slide actions are used to generate nine normal key presses per button. The circle motions are used to enable alternative key actions from subsequent key presses, for example, without limitation, by activating a shift, Alt or function mode, as shown by way of example in FIGS. 1B, 1C and 1D. This means that, in the present embodiment, only three buttons can generate twenty-seven characters easily. The circle motions allow for eighty-one more alternative keys. In an alternate embodiment, multiple circle motions may allow for unlimited numbers of alternative keys; for example, without limitation a double, triple or quadruple circle motion may be used to activate various different modes. Exemplary modes include, without limitation, a SHIFT mode, a CAPS LOCK mode, a SHIFT/CAPS UNLOCK mode, an ALT mode, an ALT LOCK mode, an ALT UNLOCK mode, a FUNC 1 mode, a FUNC 2 mode, a FUNC 3 mode, a FUNC X mode, and a FUNC UNLOCK mode depending on the button in which the circle is made, the direction of the circle and the configuration settings of the device set up by the user. In the present embodiment, a circle motion in the opposite direction cancels the mode. However, in alternate embodiments a circle motion in the opposite direction may activate a different mode rather than cancel the current mode.

The present embodiment also allows three motions across buttons 101, 103 and 105, a long slide motion, a large circle or “V” motion and a large zigzag motion. A long slide motion from left button 101 to right button 105 through central button 103 produces a space, as shown by way of example in FIG. 1I. A long slide motion from right button 105 to left button 101 through central button 103 produces a delete, as shown by way of example in FIG. 1H. A large circle or “V” slide motion from left button 101 to right button 105 through central button 103 and back to left button 101 produces a return as shown by way of example in FIG. 1J. A circle or “V” slide motion in the other direction, from right button 105 to left button 101 through central button 103 and back to right button 105, also produces a return. However, in alternate embodiments, this motion may perform various other tasks such as, but not limited to, going to the top of the screen, going to the previous or subsequent page, producing a tab, etc. A zigzag slide motion from left button 101 to right button 105 through central button 103, back to left button 101 and then back once more to right button 105 enables the user to toggle virtual keyboard 100 on or off if the device on which virtual keyboard 100 is being used has this capability. A zigzag slide motion is illustrated by way of example in FIG. 1K. A zigzag slide motion in the other direction, from right button 105 to left button 101 through central button 103, back to right button 105 and back once more to left button 101, also may toggle virtual keyboard 100 on or off if the device is capable of this or may perform a different task. In an alternate embodiment with a multi touch keyboard, the space, delete, return and keyboard toggle actions may be a shorter slide or a set of shorter slides with two or more fingers in contact with the screen while sliding rather than a long slide with one finger. Those skilled in the art, in light of the present teachings, will readily recognize that alternate embodiments may enable other types of motions across the buttons such as, but not limited to, multiple circle motions, diagonal slides, multiple square shaped motions, multiple triangular shaped motions, multiple star shaped motions where the stars have many points, multiple figure of eight motions, multiple fish shaped motions, etc. Furthermore, the actions previously described may be programmed to perform different functions from those listed above. For example, without limitation, a long slide to the right may be a return or may send a message rather than create a space, or a long slide to the left may go to the previous page rather than delete.

The key layout on buttons 101, 103 and 105 may be any layout that the platform owner desires. However, a common layout is a QWERTY approximation layout, as shown by way of example in FIGS. 1A and 1B. Other exemplary layouts include, without limitation, an alphabetical layout where the left button comprises letters A through I, the center button comprises letters J through R and the right button comprises letters S through Z, and alphabetical layout with the letters listed across all three buttons horizontally or common alternatives to QWERTY or DVORAK.

In typical use of the present embodiment, a user can use one thumb to activate any key. Alternatively, a user can place his index, middle and ring fingers directly above buttons 101, 103 and 105, respectively. In this usage scenario, a user need only make minimal movements with his hand, and on a mobile device the user can gain haptic feedback on the edge of the screen with his ring and index fingers. Due to the size of buttons 101, 103 and 105, the haptic feedback and the lack of a need to make major hand movements, it is possible to touch type very quickly on a device using virtual keyboard 100. The ability to have a familiar key layout enables a user to quickly become familiar with virtual keyboard 100 and to get up to speed after learning the intuitive compass, left and right and circle slide actions.

A number of visual queues can be added to virtual keyboard 100. For example, without limitation, when one of the three buttons is pressed, the keyboard guide area may highlight the currently selected key. Another potential visual queue is a display of the current letter or action that will be generated on virtual keyboard 100 if the user removes his finger from the screen at that point in time. Other exemplary visual queues that may be added to virtual keyboard 100 include, without limitation, various cursors, a display indicating what mode the keyboard is in, a line tracing the movement of the finger, etc.

Some embodiments of the present invention may have the ability to adjust the various sensitivities of different movement directions for different buttons to compensate for different users' habitual mistakes. For example, without limitation, a user might be less accurate at generating characters along diagonals on one or more buttons. In this example, the program keeps statistics on the number of times a key is pressed and also infers the number of times a key is pressed in error and which keys are pressed in place of the correct key by determining which characters are deleted. The program then measures the ratio of errors to accurate clicks, and, if this ratio goes below a certain predefined target, the current target region for the relevant key is extended. The target region for the relevant key is defined as the area on the touch screen of a device where, if tapped by a user, that tap is recognized by the software program as relating to that key. The amount and direction that the target region is extended is based on the keys that the user presses in error. The regions will not extend beyond a maximum amount so as to always allow all nine slide and tap motions to be possible.

FIGS. 1E through 1K illustrate exemplary actions that may be performed by a user of an exemplary virtual keyboard 100, in accordance with an embodiment of the present invention. FIGS. 1E, 1F and 1G illustrate actions for entering text, specifically a tap, a slide and a tap and a combination of separate taps and slides, respectively. FIGS. 1H, 1I, 1J, and 1K illustrate actions that a user may execute to perform specific functions, specifically a delete action, a space action, a return action, and a stop/start or open/close action, respectively. In the present embodiment a program on the device on which virtual keyboard 100 is operated, after bounded areas for the buttons are defined, iteratively performs the following tasks. The program records when a user makes contact with the screen, for example, without limitation, with their finger or fingers if multiple contacts are made. The program records the path that a user's finger or fingers take on the screen while in contact with virtual keyboard 100. As the user is moving his finger across the screen of virtual keyboard 100, the program constantly calculates what type of movement the user is making with his finger. If the user has not moved his finger, the program determines that the central key of the button is tapped or pressed. This key depends on the button pressed and the mode of virtual keyboard 100. The user may also move his finger in one of eight directions: north, south, east, west, north east, north west, south east, and south west. If the user moves his finger, the program determines which direction the movement is in by calculating the angle between the point of contact of the finger and the current position of the finger rounded to the nearest 45 degree point (e.g., 0, 45, 90, 135, 180, 225, 270 and 315 degrees). These actions generate a character or symbol, or combination of characters and symbols, or execute some code, or call a function, depending on the button pressed and the mode of virtual keyboard 100. The program detects when the user releases the virtual keyboard 100 and displays the relevant character based on the logic provided above. For example, without limitation, referring to FIG. 1E, a dot 113 represents where a user presses or taps a button 101 with virtual keyboard 100 in lower case QWERTY mode. An “s” is displayed in a display screen of virtual keyboard 100. Referring to FIG. 1F, an arrow 115 represents the user sliding his finger north, and a “w” is displayed. The screen displays the letter that the user is touching. For example, without limitation, if the user adjusts and slides west a little from the w, at some point the screen moves from displaying a “w” to displaying a “q” as the user's relative position from the start point moves to be closer to the north west direction than the north direction. If the user lifts his finger from virtual keyboard 100 when in the north west position, the “q” character is added to the text output on the display screen. Referring to FIG. 1G, the movements required by a user to input the message “call home soon” on virtual keyboard 100 are shown with dots representing taps and arrows representing slides. In the present example, the user lifts his finger at the end of each slide. The device displays continually, if configured to do so, on the screen at a display point. For example, without limitation, just above virtual keyboard 100 or at the end of the point on the screen where the output is due to be placed (e.g., at the point of the cursor in a word processing application) a symbol that identifies what character will be generated if the user decides to end contact with the touch screen is displayed.

Referring to FIGS. 1B, 1C and 1D, the user may also trace a circular motion on one of the three buttons 101, 103 and 105, clockwise or counterclockwise, and return near the original position. This circular action changes the mode of the virtual keyboard.

The user may also make specific movements that instruct the device to perform a function. One such exemplary movement is a movement from left to right or from right to left, which begins on a far right button 105 and finishes on left button 101 or vice versa. This action instructs the device to insert a space when in the left to right direction, as shown by way of example in FIG. 1I, or delete a character when in the right to left direction, as shown by way of example in FIG. 1H. Referring to FIG. 1H, an arrow 117 illustrates an exemplary delete action, and referring to FIG. 1I, an arrow 119 illustrates an exemplary space action. In the case of multi touch input, the program records if the user has moved left or right, and only a small motion is required. This action initiates a space function or a delete function depending on direction of the movement. Referring to FIG. 1J, another exemplary movement for performing a function is a motion from left button 101 to right button 105 and back to left button 101 or vice versa. These actions perform a return. An arrow 121 illustrates an exemplary return movement. Referring to FIG. 1K, if a user makes contact with left button 101, slides to right button 105, then back to left button 101 and finally back to right button 105 or vice versa, the program deactivates virtual keyboard 100. An arrow 123 illustrates an exemplary deactivation movement. If the operating system of the target platform allows the same motion while not in keyboard mode, virtual keyboard 100 may be activated using this motion as well. Alternate embodiments of the present invention may enable additional or alternate motions to perform these and other functions.

FIG. 2 illustrates an exemplary virtual keyboard 200 with keyboard guide areas 207, 209 and 211 at the top of the screen, in accordance with an embodiment of the present invention. It is important to note that being a virtual keyboard and most motions being relative as opposed to absolute as with most other keyboards, it is not necessary to have keyboard guide areas 207, 209 and 211 for each button actually on the buttons. In the present embodiment, keyboard guide area 207, 209 and 211 are at the top of virtual keyboard 200, yet the user may still select button areas 201, 203 and 205 at the bottom of the screen. The actions that may be performed by the user in the previous embodiments, for example, without limitation, taps, slides and circle motions may also be performed in button areas 201, 203 and 205 in the present embodiment. In an alternate embodiment the keyboard guide areas and the button areas may both be at the top or any other area of the screen.

In alternate embodiments, the movements used to perform certain functions on a virtual keyboard may be applied to generate input on three buttoned computer mice and joypads for example, without limitation, joypads for console games. This provides for at least three bounded areas to be defined. The fundamental logic of recognizing three buttons along with eight sliding, two rotating and one clicking action in order to allow the production of text using input devices not originally optimized for this purpose such as, but not limited to, touch screens, joypads and mice is still the same. The method for interpreting the movements to identify the button and the action the user is performing on the button is slightly different for each input device due to their different physical nature.

In an embodiment on a joypad, the movements are replicated by the following actions. Pressing one of three buttons on the joypad and the moving a joypad joystick in one of eight directions replicates the eight sliding motions per key in defined bounded areas. Pressing one of the three buttons on the joypad replicates the clicking or tapping of keys. Pressing one of the three buttons on the joypad and the rolling the joypad joystick in a clockwise or counterclockwise circle replicates the counterclockwise and clockwise sliding circle motions. Right, left, down, and up movements of the joypad joystick may be used to replicate the actions of inputting a space, deleting, inputting a return, and deactivating the keyboard mode. Pressing one of the three buttons on the joypad for a prolonged period of time replicates the touch and hold functionality. A similar adjustment may be made for embodiments on a three-button mouse where a combination of button presses and mouse movements may be used to replicate the movements previously described.

Devices that implement software for recognizing these movements would be enhanced to recognize a joypad or three-button mouse as an input device as well as a touch screen where these input devices are present. Any or all of the input devices may be present in a system and none are mandatory. By recognizing these various input devices, the applicable computer systems on which this software may run is broadened to include systems such as, but not limited to, games consoles and any computer system with a mouse. Those skilled in the art, in light of the present teachings, will readily recognize that alternate types of input devices may also implement this software such as, but not limited to, trackballs, digital tablets, remote controls, etc.

Alternate embodiments of the present invention may include implementations where all sliding actions kept within a button, more than 8 directions are recognized, have more than 3 buttons, have less than 3 buttons, have an action which could be performed more than once to generate a symbol or character, or have a character which is generated in the opposite direction of the arrow.

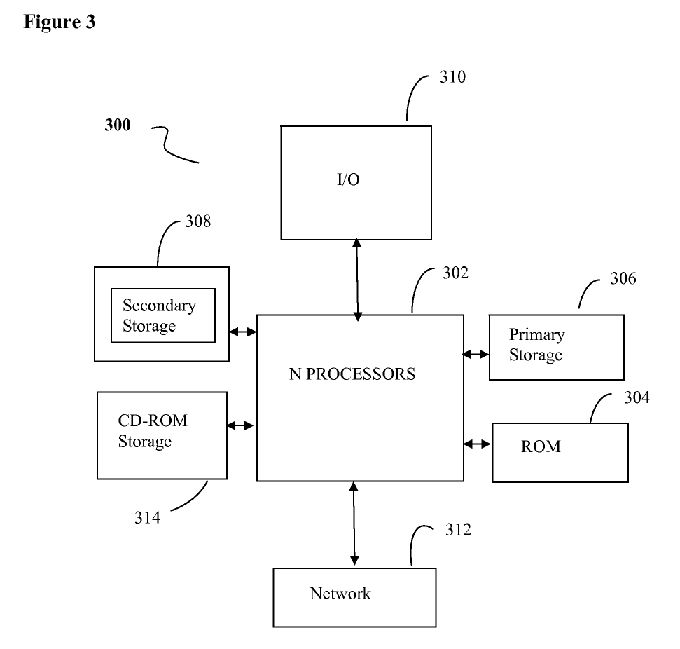

FIG. 3 illustrates a typical computer system that, when appropriately configured or designed, can serve as a computer system in which the invention may be embodied. The computer system 300 includes any number of processors 302 (also referred to as central processing units, or CPUs) that are coupled to storage devices including primary storage 306 (typically a random access memory, or RAM), primary storage 304 (typically a read only memory, or ROM). CPU 302 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 304 acts to transfer data and instructions uni-directionally to the CPU and primary storage 306 is used typically to transfer data and instructions in a bi-directional manner. Both of these primary storage devices may include any suitable computer-readable media such as those described above. A mass storage device 308 may also be coupled bi-directionally to CPU 302 and provides additional data storage capacity and may include any of the computer-readable media described above. Mass storage device 308 may be used to store programs, data and the like and is typically a secondary storage medium such as a hard disk. It will be appreciated that the information retained within the mass storage device 308, may, in appropriate cases, be incorporated in standard fashion as part of primary storage 306 as virtual memory. A specific mass storage device such as a CD-ROM 314 may also pass data uni-directionally to the CPU.

CPU 302 may also be coupled to an interface 310 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 302 optionally may be coupled to an external device such as a database or a computer or telecommunications or internet network using an external connection as shown generally at 312, which may be implemented as a hardwired or wireless communications link using suitable conventional technologies. With such a connection, it is contemplated that the CPU might receive information from the network, or might output information to the network in the course of performing the method steps described in the teachings of the present invention.

Those skilled in the art, in light of the present teachings, will readily recognize that it would be possible, where the buttons do not occupy all of the available screen space, to add “n” number of normal keyboard buttons in addition to the 3 button keyboard guide area, that make available other functions such as to start an application, open up an option menu, change settings, replicate arrow key functions, etc.

In alternative embodiments, the movements used to perform certain functions on a virtual keyboard may be applied to generate input on a one buttoned number pad, for example, without limitation, as a phone dialer. One of eight directions and a dot would replicate the numbers 1 to 9 and a circular motion would replicate zero. Left zigzag or a multi-touch left to right slide to start the call and a right zigzag or multi-touch tap to end the call. A square motion would represent the # or hash key and a triangular motion would represent the star or * key. The whole screen could be one large button.

An embodiment with 3 buttons and a standard QWERTY layout could be used anywhere a normal QWERTY hard keyboard could be used, for example, in a word processor, in a data entry application, in a web browser, or other messaging applications e.g. text messaging, or in an email application, etc.

In an alternative embodiment on a joypad, the 3 but toned software could be used as a part of the computer game to allow players to send messages to each other, or to enter scores, etc.

In an alternative embodiment for touch screen devices capable of detecting multiple contacts (known as multi-touch screen devices), the software could be adapted to interpret the pressing of up to 5 fingers (multi-finger press) to determine whether the user is requesting the subsequent sliding action to activate characters associated with one button of a 3 or more buttoned embodiment, and to activate commonly used functions such as space, delete and return etc. For example, without limitation, three fingers pressing together anywhere on the screen will generate a character associated with the 3^{rd} button.

In an alternative embodiment for touch screen phone devices the software could be adapted as a Braille virtual keyboard, enabling users to touch type rapidly without the need to carry and attach a separate, bulky Braille hard keyboard.

In an alternative embodiment for touch screen phone devices the software could incorporate a predictive function whereby a user will be presented with one large prediction button above on in place of the 3 normal keyboard buttons. When the user types the software will predict the letter typed intended as one of the 3 letters corresponding to the analogous letter on each keyboard button. For example, if a user slides diagonally to the up and right on this prediction button the system will now that they intended to generate an “e”, “y” or “o” in the preferred QWERTY embodiment. The system would use word frequency, letter frequency and any inbuilt dictionary to intelligent predict what is the most likely letter or word intended.

In an alternative embodiment for touch screen phone devices with an accelerometer, electronic compass, camera or other system capable of measuring movement to detect 3 specific location or orientation changes in conjunction with sliding or tapping actions on one large button. For example, a device equipped with an accelerometer could be tilted to the right, center or left by the user while combined with the relevant sliding or tapping motion on the one large button.

Having fully described at least one embodiment of the present invention, other equivalent or alternative methods of providing a virtual keyboard according to the present invention will be apparent to those skilled in the art. The invention has been described above by way of illustration, and the specific embodiments disclosed are not intended to limit the invention to the particular forms disclosed. For example, the particular implementation of the keyboard guide areas may vary depending upon the particular type of buttons used. The buttons and keyboard guide areas described in the foregoing were directed to rectangular and square implementations; however, similar techniques are to provide buttons and keyboard guide areas in various shapes such as, but not limited to, circles and ovals. Alternately shaped implementations of the present invention are contemplated as within the scope of the present invention. The invention is thus to cover all modifications, equivalents, and alternatives falling within the spirit and scope of the following claims.

What is claimed is:

1. A method for a virtual keyboard utilizing a computer input device, the method comprising steps of:
defining at least first, second and third bounded areas associated with the input device;
assigning a set of nine characters to each of said bounded areas;
detecting contacts and movements associated with the input device within said bounded areas;
selecting a one of eight of said nine characters assigned to a bounded area upon detection of a continuous contact during a movement from a beginning position to an end position associated with said bounded area, wherein said selecting being determined by a linear direction from said beginning position to said end position; and
selecting a ninth of said nine characters assigned to said bounded area upon detection of a momentary contact associated with said bounded area.

2. The method as recited in claim 1, further comprising a step of assigning a different set of nine characters to each of said bounded areas upon detection of a continuous contact during a generally circular movement associated with a bounded area.

3. The method as recited in claim 1, further comprising a step of assigning a different set of nine characters to each of said bounded areas upon detection of a continuous contact for a predetermined time without movement.

4. The method as recited in claim 1, wherein the computer input device comprises a touch input of a display screen and said bounded areas are defined adjacently.

5. The method as recited in claim 4, further comprising a step of selecting a space character upon detection of a continuous contact during a movement from said first bounded area through said second bounded area to said third bounded area.

6. The method as recited in claim 4, further comprising a step of selecting a backspace character upon detection of a continuous contact during a movement from said third bounded area through said second bounded area to said first bounded area.

7. The method as recited in claim 4, further comprising a step of selecting a return character upon detection of continuous contact during a movement passing through said bounded areas twice.

8. The method as recited in claim 4, further comprising a step deactivating said detection upon detection of continuous contact during a movement passing through said bounded areas three times.

9. A method for a virtual keyboard utilizing a computer input device, the method comprising:
steps for defining bounded areas associated with the input device;
steps for assigning characters to each of said bounded areas;
steps for detecting contacts and movements within said bounded areas;
steps for selecting characters upon detection of a continuous contact during a movement; and
steps for selecting characters upon detection of a momentary contact.

10. The method as recited in claim 9, further comprising steps for assigning different characters to each of said bounded areas.

11. The method as recited in claim 9, further comprising steps for selecting a space character.

12. The method as recited in claim 9, further comprising steps for selecting a backspace character.

13. The method as recited in claim 9, further comprising steps for of selecting a return character.

14. The method as recited in claim 9, further comprising steps for deactivating said detection.

15. A computer program product for a virtual keyboard utilizing a computer input device, the computer program product comprising:
computer code for defining at least first, second and third bounded areas associated with the input device;
computer code for assigning a set of nine characters to each of said bounded areas;
computer code detecting contacts and movements associated with the input device within said bounded areas;
computer code for selecting a one of eight of said nine characters assigned to a bounded area upon detection of a continuous contact during a movement from a beginning position to an end position associated with said bounded area, wherein said selecting being determined by a linear direction from said beginning position to said end position;
computer code for selecting a ninth of said nine characters assigned to said bounded area upon detection of a momentary contact associated with said bounded area; and
a computer-readable medium for storing said computer code.

16. The computer program product as recited in claim 15, further comprising computer code for assigning a different set of nine characters to each of said bounded areas upon detection of a continuous contact during a generally circular movement associated with a bounded area.

17. The computer program product as recited in claim 15, further comprising computer code for assigning a different set of nine characters to each of said bounded areas upon detection of a continuous contact for a predetermined time without movement.

18. The computer program product as recited in claim 15, wherein the computer input device comprises a touch input of a display screen and said bounded areas are defined adjacently.

19. The computer program product as recited in claim 18, further comprising computer code for selecting a space character upon detection of a continuous contact during a movement from said first bounded area through said second bounded area to said third bounded area.

20. The computer program product as recited in claim 18, further comprising computer code for selecting a backspace character upon detection of a continuous contact during a movement from said third bounded area through said second bounded area to said first bounded area.

21. The computer program product as recited in claim 18, further comprising computer code for selecting a return character upon detection of continuous contact during a movement passing through said bounded areas twice.

22. The computer program product as recited in claim 18, further comprising computer code for deactivating said detection upon detection of continuous contact during a movement passing through said bounded areas three times.

23. A system for a virtual keyboard utilizing a computer input device, the system comprising:
means for defining bounded areas associated with the input device;
means for assigning characters to each of said bounded areas;
means for detecting contacts and movements within said bounded areas;
means for selecting a characters upon detection of a continuous contact during a movement; and
means for selecting a characters upon detection of a momentary contact.

24. The system as recited in claim 23, further comprising means for assigning different characters to each of said bounded areas.

25. The system as recited in claim 23, further comprising means for selecting a space character.

26. The system as recited in claim 23, further comprising means for selecting a backspace character.

27. The system as recited in claim 23, further comprising means for of selecting a return character.

28. The system as recited in claim 23, further comprising means for deactivating said detection.
